(19) United States
(12) Patent Application Publication
(10) Pub. No.: US 2018/0121550 A1
(43) Pub. Date: May 3, 2018

(54) Ranking Search Results Based on Lookalike Users on Online Social Networks

(71) Applicant: Facebook, Inc., Menlo Park, CA (US)

(72) Inventors: Sung-eok Jeon, Bellevue, WA (US); Aliasgar Mumtaz Husain, Milpitas, CA (US)

(21) Appl. No.: 15/337,832

(22) Filed: Oct. 28, 2016

(51) Int. Cl. G06F 17/30; H04L 29/08; G06N 99/00

(52) U.S. Cl. CPC G06F 17/30867; G06N 99/005; H04L 67/22

(57) ABSTRACT

In one embodiment, a method includes accessing lookalike data in response to a search query, wherein the lookalike data is associated with lookalike users with respect to the querying user, wherein the querying user corresponds to a first user-vector, the lookalike users being selected from a plurality of second users of an online social network that each correspond to a plurality of second user-vectors, wherein each dimension of the user-vector corresponds to a social-networking trait of the respective user. Each second user is selected based on a vector similarity between the querying user-vector and the second-user vector. The method further includes calculating, by a machine-learning model associated with the querying user, a relevancy score for each of the identified content objects, wherein the relevancy score is based on one or more prior interactions of one or more of the lookalike users with content objects associated with the online social network.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may rank search results based not only on their relevancy to the search query, but also on the social-networking activity of “lookalike” users. Lookalike users may be users that have similar attributes as the querying user. In prior search engine systems, when processing a search query from a particular user, the search engine system may rank the search results based on the relevance of the search result to the query, but not necessarily the relevance of the search result to the querying user. This may lead to users performing multiple queries to find relevant results, consuming additional time and processing resources. The embodiments described herein may improve upon prior search engines by returning more relevant search results that are based not only on the text of the search query, but also on how other users that are similar to the querying user have interacted with objects referenced in search results. This may provide a more customized search experience and may provide search results more efficiently and reduce the requisite processing power by reducing the number of queries inputted by users. The social-networking system may determine whether users A and B are lookalike users by representing each user as a user-vector. After the social-networking system has generated user-vectors for two or more users, it may measure the vector similarity (e.g., cosine similarity, Euclidean distance) between two user-vectors to determine if the users may be deemed to be lookalike users. A user may be considered a lookalike user with respect to the querying user if, for example, the cosine similarity between their respective user-vectors is above a threshold similarity value. As an example and not by way of limitation, a user a user Alex may be a Mexican-American male, aged 24, who attends Stanford University, and who has liked the Tim Duncan fan page, and has checked-in at Umami Burger in Palo Alto, Calif. Each of these pieces of information relating to Alex's social-networking activity may be coded and become part of a user-vector that represents Alex. The social-networking system may create a user-vector for Alex that may look something like, <2, 5, 0, 0, 3, −2>, where each value in the user-vector represents some social-networking trait (e.g., 2=male, 5=age 21-25; −2=likes Tim Duncan). This user-vector may have more or fewer dimensions depending on the number of social-networking traits considered when determining lookalikes and the amount of information available to the social-networking system. If two users have a vector similarity value above a threshold similarity value (e.g., a cosine similarity greater than 0.7), they may be deemed to be lookalike users. Depending on the threshold, the querying user may have tens, hundreds, or thousands of lookalike users.

When the social-networking system receives a search query from a user, it may identify content objects (e.g., posts, profile pages, photos) that match the search query. It may then access lookalike data as described above. Using the lookalike data, the social-networking system may calculate a relevancy score for each of the identified content objects. The relevancy score may be calculated using a machine-learning model associated with the querying user. The relevancy score may be based on prior interactions by the querying user's lookalike users with content objects associated with the online social network. The social-networking system may then rank the content objects at least in part based on the relevancy score of each content object (e.g., a content object with a high relevancy score may be ranked higher than it would if it had a low relevancy score). As an example and not by way of limitation, a user, Alex may input a search query that says “knife sharpener.” The social-networking system may identify content objects that match the search query. The matching content objects may include an Amazon page listing a knife sharpener available for purchase, a video demonstrating how to sharpen a knife without a knife sharpener, and a profile interface (e.g., Facebook profile page) to a professional knife sharpening company. Alex's lookalike users may have interacted with (e.g., viewed, liked, shared, posted, commented on) the video demonstrating how to sharpen a knife without a knife sharpener more than they interacted with the other two content objects. As a result, the social-networking system may calculate a higher relevancy score for the video than for the other two content objects, and also rank the video higher in a search-results interface.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example view of an embedding space.

FIG. 4 illustrates an example view of a vector space.

FIG. 5 illustrates an example search-results interface.

FIG. 6 illustrates an example method for ranking search results based on social data from lookalike users.

FIG. 7 illustrates an example computer system.

### DESCRIPTION OF EXAMPLE EMBODIMENTS

### System Overview

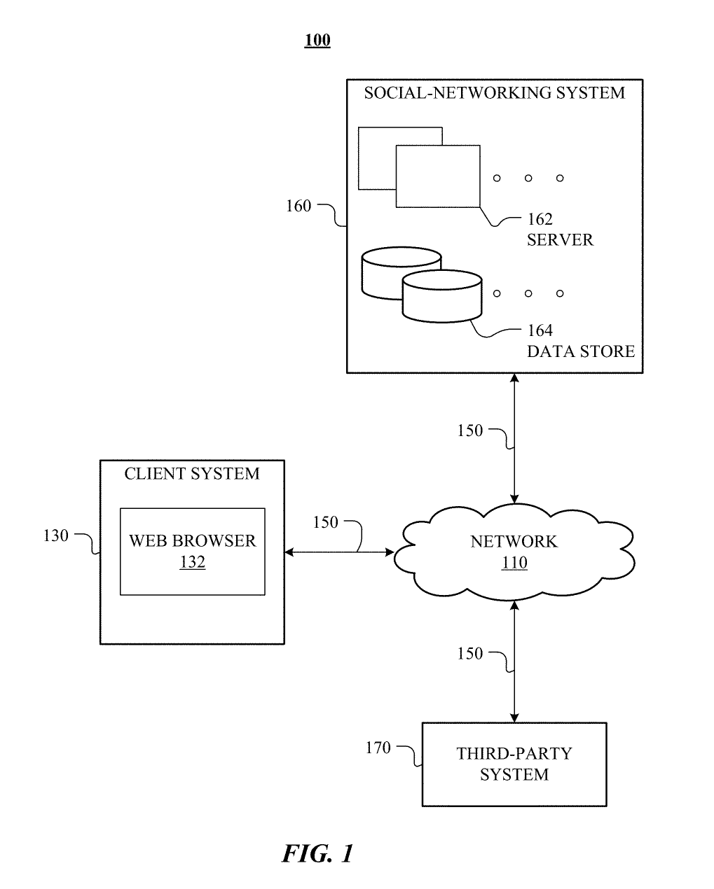

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

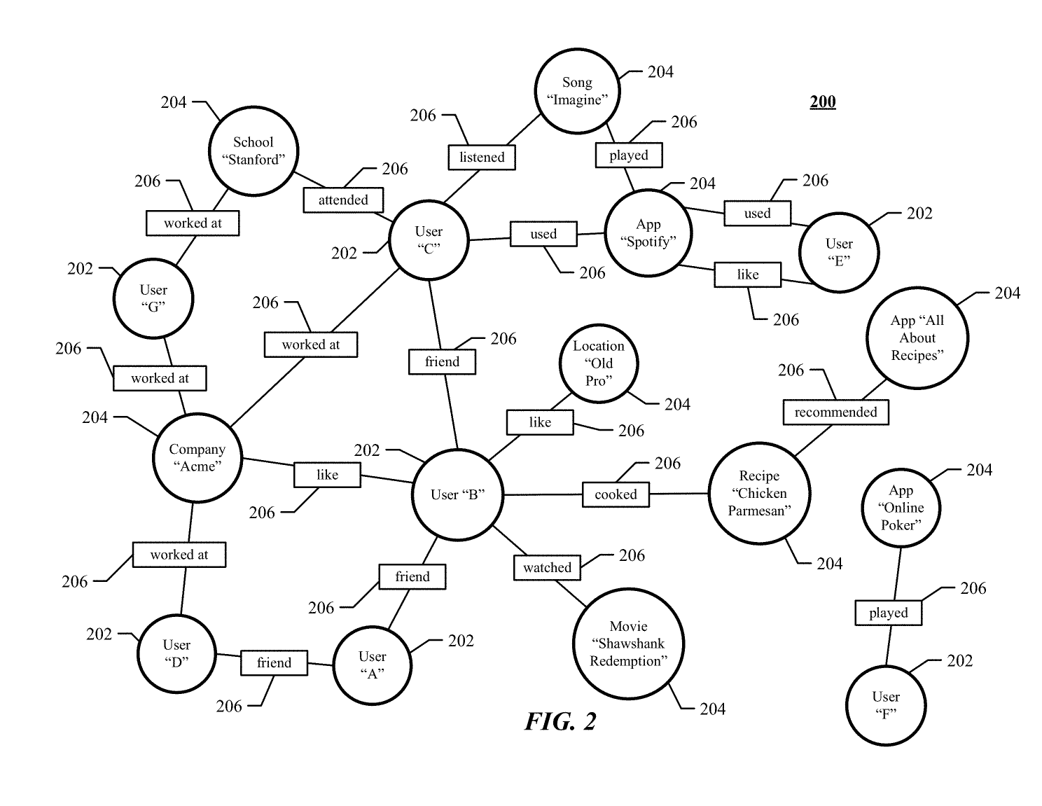

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

### Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763162, filed 19 Apr. 2010, and U.S. patent application Ser. No. 13/556072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, and U.S. patent application Ser. No. 12/978265, filed 23 Dec. 2010, which are incorporated by reference.

### Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556072, filed 23 Jul. 2012, U.S. patent application Ser. No. 13/731866, filed 31 Dec. 2012, and U.S. patent application Ser. No. 13/732101, filed 31 Dec. 2012, each of which is incorporated by reference. More information on structured search queries and grammar models may be found in U.S. patent application Ser. No. 13/556072, filed 23 Jul. 2012, U.S. patent application Ser. No. 13/674695, filed 12 Nov. 2012, and U.S. patent application Ser. No. 13/731866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner. More information on keyword queries may be found in U.S. patent application Ser. No. 14/244748, filed 3 Apr. 2014, U.S. patent application Ser. No. 14/470607, filed 27 Aug. 2014, and U.S. patent application Ser. No. 14/561418, filed 5 Dec. 2014, each of which is incorporated by reference.

Ranking Search Results based on Lookalike User Activity

In particular embodiments, when processing a search query from a particular user, the social-networking system 160 may rank search results based on the social-networking activity of “lookalike” users with respect to the querying user. Lookalike users may be users that have similar attributes (e.g., social-networking traits) as the querying user. In prior search engine systems, when processing a search query from a particular user, the search engine system may rank the search results based on the relevance of the search result to the query, but not necessarily the relevance of the search result to the querying user. This may lead to users performing multiple queries to find relevant results, consuming additional time and processing resources. The embodiments described herein may improve upon prior search engines by returning more relevant search results that are based not only on the text of the search query, but also on how other users that are similar to the querying user have interacted with objects referenced in search results. This may provide a more customized search experience and may provide search results more efficiently and reduce the requisite processing power by reducing the number of queries inputted by users. The social-networking system 160 may determine whether users A and B are lookalike users by representing each user as a user-vector having N dimensions in an N-dimensional vector space. Each dimension in the vector space may correspond to a particular social-networking trait. After the social-networking system 160 has generated user-vectors for two or more users, it may measure the vector similarity (e.g., cosine similarity, Euclidean distance) between the two user-vectors to determine if the users may be deemed to be lookalike users. A user may be considered a lookalike user with respect to the querying user if, for example, the cosine similarity between their respective user-vectors is above a threshold similarity value. As an example and not by way of limitation, a user a user Alex may be a Mexican-American male, aged 24, who attends Stanford University, and who has liked the Tim Duncan fan page, and has checked-in at Umami Burger in Palo Alto, Calif. Each of these pieces of information relating to Alex's social-networking activity may be coded and become part of a user-vector that represents Alex. The social-networking system 160 may create a user-vector for Alex that may look something like, <2, 5, 0, 0, 3, −2>, where each value in the vector represents some trait (e.g., 2=male, 5=age 21-25; −2=likes Tim Duncan). This user-vector may have more or fewer dimensions depending on the number of social-networking traits considered when determining lookalikes and the amount of information available to the social-networking system 160. If two users have a vector similarity value above a threshold similarity value (e.g., a cosine similarity greater than 0.7), they may be deemed to be lookalike users. Depending on the threshold, the querying user may have tens, hundreds, or thousands of lookalike users.

When the social-networking system 160 receives a search query from a user, it may identify content objects (e.g., posts, profile pages, photos) that match the search query. It may then access lookalike data as described above. Using the lookalike data, the social-networking system 160 may calculate a relevancy score for each of the identified content objects. The relevancy score may be calculated using a machine-learning model associated with the querying user. The relevancy score may be based on prior interactions by the querying user's lookalike users with content objects associated with the online social network. The social-networking system 160 may then rank the content objects at least in part based on the relevancy score of each content object (e.g., a content object with a high relevancy score may be ranked higher than it would if it had a low relevancy score). As an example and not by way of limitation, a user, Alex may input a search query that says “knife sharpener.” The social-networking system 160 may identify content objects that match the search query. The matching content objects may include an Amazon page listing a knife sharpener available for purchase, a video demonstrating how to sharpen a knife without a knife sharpener, and a profile interface (e.g., Facebook page) to a professional knife sharpening company. Alex's lookalike users may have interacted with (e.g., viewed, liked, shared, posted, commented on) the video demonstrating how to sharpen a knife without a knife sharpener more than they interacted with the other two content objects. As a result, the social-networking system 160 may calculate a higher relevancy score for the video than for the other two content objects.

Identifying Lookalike Users

In particular embodiments, the social-networking system 160 may receive, from the client system 130 of a querying user, a search query comprising a plurality of n-grams inputted by the first user. The search query may comprise any number or combination of n-grams related to any topic. As an example and not by way of limitation, the social-networking system 160 may receive a search query that states, “vacation destinations.” Although this disclosure describes receiving particular search queries in a particular manner, this disclosure describes receiving any suitable search queries in any suitable manner.

In particular embodiments, the social-networking system 160 may identify a plurality of content objects associated with the online social network that match the plurality of n-grams in the search query. A content object may comprise any type of object that is posted to or otherwise associated with the online social network. Example content objects include photos, videos, user status updates, comments, geo-tags, a profile page associated with an entity (e.g., a user, a business, a group), user reactions to posts or comments (e.g., “like”), other types of multimedia content or structured documents, or any other suitable object. Content objects or references to content objects may be stored in associated with the social graph 200. For a content object to match an n-gram, the content object may need to be related to the n-gram in some way. As an example and not by way of limitation, a querying user may input the text “dat donut” into a search query input field, and the social-networking system 160 may identify a profile page for a business called Dat Donut, a user post that says, “Happy Birthday Shannon! Eat an extra dat donut for me!”, a photo with the caption “Dat Big Donut,” and other content objects that that are related to the n-grams in the text string “dat donut.” Although this disclosure describes identifying particular content objects in a particular manner, this disclosure contemplates identifying any suitable content objects in any suitable manner.

In particular embodiments, the social-networking system 160 may access lookalike data of one or more lookalike users with respect to the querying user. Lookalike data, as used herein, may be understood to mean social-networking data associated with a user who “looks like” the querying user. Lookalike data may include social-networking traits associated with the particular lookalike user. In particular embodiments, user lookalike data may include content objects that the lookalike user has liked, posted, shared, commented on, reacted to, or had any interaction with, as well as the particular interaction with a particular content object. These actions may be considered to be prior interactions that the user has taken in association with the online social network. In particular embodiments, the prior interactions of lookalike users may include viewing, accessing, liking, sharing, commenting on, or reacting to content objects associated with the online social network. In particular embodiments, the prior interactions of the lookalike users may include click-through data associated with search results previously presented to the lookalike user. Lookalike data may further include profile information, such as sex/gender, place of residence, education information, political preference, and any other suitable information a user may provide to the social-networking system 160. Lookalike data may be stored by the social-networking system 160 in association with the social graph 200. As explained above, the social graph 200 may comprise social-networking data associated with a user of the online social network. This data may be represented in the form of a user node 202 that corresponds to the user and edges 206 that connects the user node 202 to other nodes in the social graph 200. The nodes may correspond to content objects (e.g., entity pages, posts, photos, videos, comments). An edge 206 may have a particular edge type. Each edge type may correspond to a particular interaction the user has taken with respect to a particular content object associated with the online social network. As an example and not by way of limitation, if a user attends Stanford University, the user node 202 associated with that user may have an edge 206 with an “attends” edge type connecting the user node 202 to the concept node 204 corresponding to Stanford University. This information may be considered to be social-networking data associated with a given user, or if the information is associated with a lookalike user, this information may be considered to be lookalike data. In particular embodiments, a user may be a lookalike user with respect to the querying user if her social-networking data is sufficiently similar to that of the querying user. As an example and not by way of limitation, if a user Brittany has social-networking data that is sufficiently similar to that of the querying user, Alex, Brittany may be a lookalike user with respect to Alex, and Brittany's social-networking data may be thought of as lookalike data. Although this disclosure describes accessing particular lookalike data in a particular manner, this disclosure contemplates accessing any suitable lookalike data in any suitable manner.

In particular embodiments, the social-networking system 160 may represent the querying user as an N-dimensional user-vector in an N-dimensional vector space. Each dimension of the user-vector may correspond to a social-networking trait of the querying user. As an example and not by way of limitation, a user a user Alex may be a Mexican-American male, aged 24, who attends Stanford University, and who has liked the Tim Duncan fan page, and has checked-in at Umami Burger in Palo Alto, Calif. Each of these pieces of information relating to Alex's social-networking activity may be considered to be social-networking traits. The social-networking traits may be coded (e.g., converted into a number) and become part of a user-vector that represents Alex. In other words, the social-networking traits of a particular user may be vectorized, thereby generating a vector representation of the user (i.e., a “user-vector”). The social-networking system 160 may create a user-vector for Alex that may look something like, <2, 5, 0, 0, 3, −2>, where each value in the vector represents some user trait (e.g., 2=male, 5=age 21-25). The user traits may be considered to be social-networking traits. The user-vector may have more or fewer dimensions depending on the number of social-networking traits considered when determining lookalikes, as well as on the amount of information available to the social-networking system 160. It is contemplated that a user-vector may have dozens or hundreds of dimensions (e.g., 256 dimensions), wherein each dimension represents a particular social-networking trait. The social-networking system 160 may create user-vectors for each of a plurality of users of the online social network. The plurality of users may include all the users of the online social network or a subset of users (e.g., a random subset of user, a subset of recently active users, a subset of users having a least a threshold number of traits matching the querying user, etc.). Although this disclosure discusses representing users in a particular manner, this disclosure contemplates representing users in any suitable manner.

In particular embodiments, the social-networking traits of the respective user may determined by accessing a social graph 200 comprising a plurality of nodes and a plurality of edges connecting the nodes, each of the edges between two of the nodes representing a single degree of separation between them. A particular node among the plurality of nodes may represent the particular user for which the user-vector is created. This may be referred to as a user node. The user node may itself may correspond to a user or to a user profile associated with the user, and may contain social-networking traits used to populate one or more dimensions of the user-vector. Such social-networking traits may include demographic information about the user, including, for example, the user's age, gender, political preference, education, and any other information a user may include on a user profile, as well as information related to interactions the user has had with other entities and content objects associated with the online social network. As an example and not by way of limitation, a user Alex may specify on his user profile page that he is male, age 31, has a bachelor's degree in economics, and likes Kanye West (a rap artist). Each of these data points may be represented as a social-networking trait in a user-vector in a vector space that represents Alex. As an example and not by way of limitation, this information may be represented as the vector <1, 3, 4, 18, 3452>. In this example, “1” may represent that Alex is male, “3” that he is aged 31, “4” that he has a bachelor's degree, “18” that his degree is in economics, and “3452” that he likes Kanye West. In addition to the user node 202, the edges 206 connecting the user node to other nodes in the social graph 200, as well as the other nodes themselves, may provide social-networking traits that may be used to populate one or more dimensions of the user-vector. Social graph 200 may be updated periodically or in real-time to reflect user likes, shares, comments on, or other interactions with content objects on the online social network. Social graph 200 may be updated with new nodes and new edges with various edge-types as new users join the online social network and existing users interact with content objects on the online social network. Each edge type may correspond to a specific interaction the respective user has taken with respect to another node in the social graph. This information may be used to populate the dimension in a user-vector. As an example and not by way of limitation, Alex may have posted an article on the online social network that is titled: “25 Things Only People from Big Families Will Understand.” In response to this action, social graph 200 may be updated by creating a node corresponding to the article, with a “posted” edge 206 that connects Alex's user node 202 to the concept node 204 corresponding to the article. The social-networking system 160 may use this information to populate a user-vector for Alex either by coding the information so as to convey that Alex posted this particular article, or the social-networking system 160 may analyze the n-grams in the title of the post, metadata associated with the post, or any text that Alex posted in association with the article to make further determinations about Alex. As an example and not by way of limitation, the social-networking system 160 may analyze the title of the article and conclude that it relates to large families. From this the social-networking system 160 may infer that Alex posted it because he is from a large family. The social-networking system 160 may then include this information in Alex's user-vector (e.g., a dimension in the user-vector may correspond to family size, and 3 may correspond to a large family). Although this disclosure describes creating particular user representation in a particular manner, this disclosure contemplates creating any suitable user representations in any suitable manner.

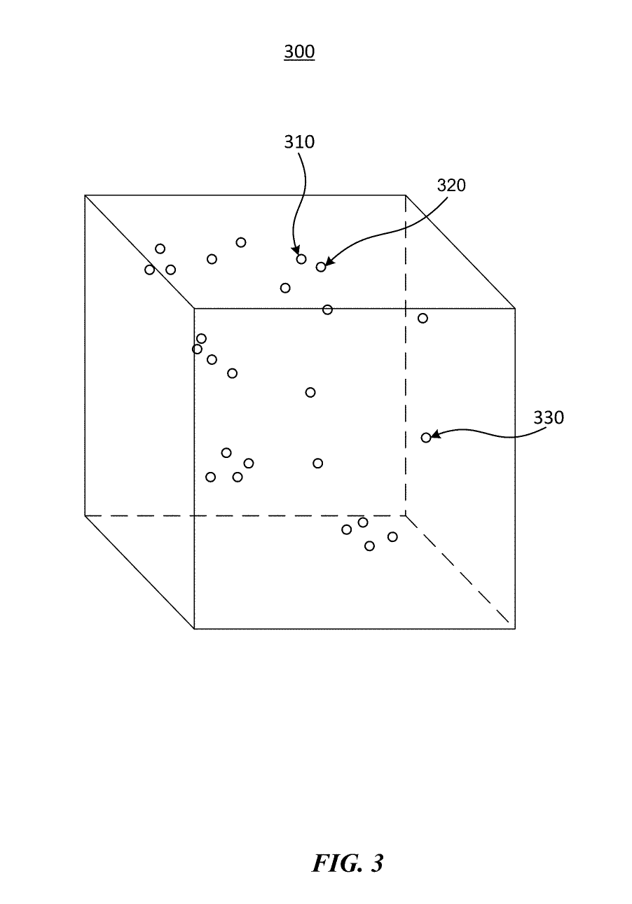

FIG. 3 illustrates an example view of an embedding space 300. In particular embodiments, users may be represented in a N-dimensional embedding space, where N denotes any suitable number of dimensions. Although the embedding space 300 is illustrated as a three-dimensional space, this is for illustrative purposes only, as the embedding space 300 may be of any suitable dimension. In particular embodiments, a user may be represented in the embedding space 300 as a user-vector, which may be referred to as a user-embedding. Each user-vector may comprise coordinates corresponding to a particular point in the embedding space 300 (i.e., the terminal point of the vector). As an example and not by way of limitation, user-embeddings 310, 320, and 330 may be represented as points in the embedding space 400, as illustrated in FIG. 3. A user may be mapped to a respective user-vector representation. As an example and not by way of limitation, users t₁ and t₂ may be mapped to vectors [symbol] and [symbol] in the embedding space 400, respectively, by applying a function \vec{π}, such that [symbol] =\vec{π}(t₁) and [symbol] =\vec{π}(t₂). In particular embodiments, a user may be mapped to a vector representation in the embedding space 400 by using a deep-leaning model (e.g., a neural network). The deep-learning model may have been trained using a sequence of training data (e.g., a corpus of users each associated with social networking data). In particular embodiments, a user may be mapped to a user-embedding in the embedding space 300. A user-embedding \vec{π}(e) of user e may be based on one or more properties, attributes, or features of the user, relationships of the user with other users or objects, or any other suitable information associated with the user. As an example and not by way of limitation, an embedding [symbol] (e) of user e may be based on one or more users associated with user e. In particular embodiments, a user may be mapped to a user-vector representation in the embedding space 300 by using a deep-learning model. In particular embodiments, the social-networking system 160 may utilize one or more systems, components, elements, functions, methods, operations, or steps disclosed in U.S. patent application Ser. No. 14/949436, filed 23 Nov. 2015, which is incorporated by reference. Although this disclosure describes representing an n-gram or an object in an embedding space in a particular manner, this disclosure contemplates representing an n-gram or an object in an embedding space in any suitable manner.

In particular embodiments, the social-networking system 160 may calculate a similarity metric of user-embeddings in embedding space 300. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \cdot \vec{{v}_{2}} ‖} .$$

As another example and not by way of limitation, a similarity metric of [symbol] and [symbol] may be a Euclidean distance ∥ [symbol] - [symbol] ∥. A similarity metric of two user-embeddings may represent how similar the two objects corresponding to the two user-embeddings, respectively, are to one another, as measured by the distance between the two user-embeddings in the embedding space 300. As an example and not by way of limitation, user-embedding 310 and embedding 320 may correspond to users that are more similar to one another than the objects corresponding to embedding 310 and embedding 330, based on the distance between the respective embeddings.

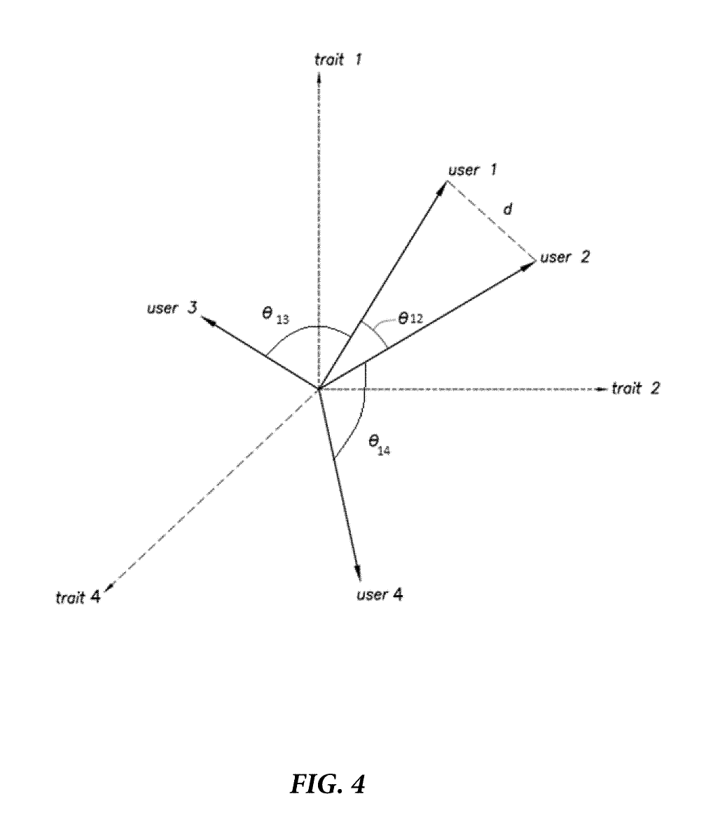

FIG. 4 illustrates an example view of a vector space. In particular embodiments, users may be represented as user-vectors in an N-dimensional vector space, wherein N denotes any suitable number of dimensions. Although the vector space in FIG. 4 is illustrated as a three-dimensional space, this is for illustrative purposes only, as the vector space may be of any suitable dimension (e.g., 128 dimensions). Each user-vector may be mapped onto the vector space. As an example and not by way of limitation, FIG. 4 illustrates four user-vectors representing user 1, user 2, user 3, and user 4. For discussion purposes, user 1 may be considered to be the querying user. As an example and not by way of limitation, user 1 may have inputted a search query that says, “best vacation destinations.” The social-networking system 160 may identify users that are lookalike users with respect to user 1 by measuring the similarity between the user-vector representing user 1 and the user-vectors representing each of the other users, respectively. Similarity may be measured in a number of different ways, including cosine similarity, Euclidean distance between the vector end-points, or any other suitable method. As an example and not by way of limitation, the angle between the user-vectors representing user 1 and user 2 in FIG. 4 may be θ₁₂. A threshold similarity may be determined, wherein user 2 may be a lookalike user with respect to user 1 if the vector similarity between their respective user-vectors is greater than the threshold similarity. As an example and not by way of limitation, the angle θ₁₂ between the user-vectors representing user 1 and user 2 may indicate that the vector similarity between the vectors is above the threshold similarity. Thus, user 1 and user 2 may be lookalike users. The angle θ₁₃ between user 1 and user 3, on the other hand, may be such that their vector similarity does not meet the threshold similarity. Thus, user 3 may not be a lookalike user with respect to user 1. The same may be said of the angle θ₁₄ between user 1 and user 4. User 4 may not be a lookalike user with respect to user 1 because the angle θ₁₄ is too large. In particular embodiments, the social-networking system 160 may consider the Euclidean distance d between the embeddings (i.e., mappings or projections of the vectors in the N-dimensional vector space) of the user-vectors in addition to or in place of cosine similarity or other angle measurement similarity. In particular embodiments, for two users to be lookalike users, the angle θ between their respective user vectors and the Euclidean distance d may both need to meet threshold values. As an example and not by way of limitation, for user 1 and user 2 to be lookalike users, the cosine similarity between their respective user-vectors must be greater than 0.8 (i.e., angle θ₁₂ must be less than or equal to 37 degrees), and the Euclidean distance between the terminal points of the user-vectors representing user 1 and user 2 must be below 5.0. A user may provide information to the social-networking system 160 by updating a user profile associated with the user with information about the user (e.g., age, relationship status, political views, interests, favorite movies, books, quotes and the like), and by interacting with content objects on the online social network (e.g., liking user posts, commenting on photos, sharing articles, posting status updates). Although this disclosure describes measuring the similarity between users in a particular manner, this disclosure contemplates measuring the similarity between users in any suitable manner.

In particular embodiments, users may be represented as binary user-vectors, wherein each value in a particular dimension in an N-dimensional user-vector is a 1 or a 0. As an example and not by way of limitation, a first binary user-vector for a user, Louie, may be <1,1,1,0,1,0,1,0>, and a second binary user-vector for another user, Quincy, may be <1,0,1,1,1,0,1,0>. These binary user-vectors may represent any suitable information relating to users of the online social network, such as whether or not the user has liked particular content objects (e.g., posts, photos, profile pages). The social-networking system 160 may calculate the similarity between Louie and Quincy by calculating the Hamming distance between the binary user-vectors for Louie and Quincy. The Hamming distance between two vectors of equal length may be the number of positions at which their corresponding bits are different. In other words, it measures the minimum number of substitutions required to change the first vector to the second vector. Thus, the difference between the binary-user vectors that represent Louie and Quincy may be 2, because two bits may need to be changed in the first binary user-vector to obtain the second binary user-vector. If the threshold Hamming distance of two binary user-vectors to be sufficiently similar for two users to be lookalike users is 3 or under, Quincy and Louie may be lookalike users, because the Hamming distance between Louie and Quincy's binary user-vectors is 2. Although this disclosure describes calculating the similarity between users in a particular manner, this disclosure contemplates calculating the similarity between users in any suitable manner.

Calculating Relevancy Scores based on Lookalike User Social-Networking Data

In particular embodiments, the social-networking system 160 may calculate, by a machine-learning model associated with the querying user, a relevancy score for each identified content object. One or more content objects may be identified as matching a particular search query, and these content objects may be referred to as the identified content objects. For each identified content object, the social-networking system 160 may calculate a relevancy score. The relevancy score may be calculated by a machine-learning model that is associated with the querying user. The relevancy score calculated for a particular content object may represent the estimated probability that the querying user will interact with the search result corresponding to the identified content object. As an example and not by way of limitation, a relevancy score for a particular content object may be 0.7, which represents a 70% estimated probability that the querying user will interact with that particular content object. The machine-learning model may take as training input the prior interactions of lookalike users of the querying user. As an example and not by way of limitation, a machine-learning model may be associated with a user Alex. The inputs of this machine learning model may be prior interactions of Alex's lookalike users. The prior interactions may be interactions that Alex's lookalike users have previously had on the online social network. Such prior interactions may include viewing, accessing, commenting on, liking, reacting to, or otherwise interacting with objects on the online social network, as well as checking in at particular locations via the online social network. Prior interactions may also include interacting with a search results interface on the online social network. As an example and not by way of limitation, Brandon may be a lookalike user of Alex. Brandon may have previously interacted with a search results interface that contained search results for vacation destinations. Brandon's interactions (e.g., click-throughs, likes, comments) with the search results interface may be used as inputs to the machine-learning model. In addition to Brandon, the prior interactions of dozens or hundreds of other of Alex's lookalike users may also be used as input to the machine-learning model associated with Alex. In particular embodiments, the machine-learning model may be a logistic regression model. In particular embodiments, the machine learning model may also take as input the prior interactions of the querying users friends and close connections. In particular embodiments, photos and videos that the querying user's lookalike users and friends have posted or interacted with may also be used as input for training purposes. As an example and not by way of limitation, one or more of Alex' lookalike users or friends may post videos related to vacations that they have recently taken. These videos may be used as training data by the machine-learning model. The machine-model may analyze these photos and videos determine that most of the photos and videos are in tropical beach environments. The social-networking system 160 may infer that the majority of Alex's lookalike users and friends prefer tropical style beach vacations. As a result, when Alex inputs the search query “vacation destinations,” the social-networking system 160 may either return more references related to tropical beach vacations, or may up-rank references that relate to tropical beach vacations. This may be because a querying user's lookalike user is likely to have similar interests as the querying user. Thus, if the majority of Alex's lookalike users love tropical beach vacations, it is likely that Alex will enjoy a tropical beach vacation also. Although this disclosure describes creating a machine-learning model in a particular manner, this disclosure contemplates creating a machine-learning model in any suitable manner.

In particular embodiments, the machine-learning model may be trained with social-networking data associated with the querying user's friends and lookalike users. Social data may be understood to mean both content data and interaction data. Content data may be the data comprised inside content objects. The machine-learning model may be trained with content data of a plurality of content objects associated with prior interactions of one or more lookalike users of the querying user. Content data may include data that is contained in the content of a content object. A content object may be a post (e.g., a user status update), a comment (e.g., a comment to a post or photo), a video, a photo, a business page (e.g., the GATORADE official profile page), a location page (e.g., the London official profile page), a user page (e.g., a user profile page), or any other object posted to or stored in association with the online social network. Examples of content data may include the text in an article, the images in a video, the title of an article, the text of a status update, and so on. As an example and not by way of limitation, a lookalike user of Alex named Brandon may have shared a photo of himself playing Basketball. The social-networking system 160 may analyze this photo and determine that it is related to basketball. The subject of the photo may be used as an input to the machine-learning model as a signal that at least one of Alex's lookalike users is interested in basketball. Because one of Alex's lookalike users is interested in basketball, this may increase the likelihood that Alex is interested in basketball. Thus, if Alex inputs a search query that states, “shoes,” references to content objects related to basketball shoes may be up-ranked relative to other styles of shoes. Interaction data may be data associated with interactions performed by users with content objects on the online social network. In particular embodiments, the machine learning model may be trained with interaction data of prior interactions with content objects by one or more of the lookalike users or friends of the querying user. The interaction data may include the type of interaction that a lookalike user has taken with respect to a particular content object (e.g., like, share, comment on, hide, ignore). These inputs may be used as training data for the machine learning model. The goal of training the machine learning model may be to train it to accurately predict which content objects a user will engage with in a search results interface. As an example and not by way of limitation, if a lookalike user hides a post related to spiders, the machine-learning model may be trained with this prior interaction (e.g., hiding the post related to spiders). Although this disclosure describes training machine-learning models in a particular manner, this disclosure contemplates training machine-learning models in any suitable manner.

In particular embodiments, a machine-learning model for a given user may calculate a relevancy score for a plurality of terms associated with the online social network independent of any search queries. The plurality of terms may include terms found in the social graph 200, in posts, in metadata, or any other suitable location. The plurality of terms may be all the terms associated with the online social network, or a subset of all the terms associated with the online social network. Example terms may include names of entities (e.g., CNN, WAL-MART, ORANGE IS THE NEW BLACK, Las Vegas), activities (e.g., running, cooking), emotions (e.g., happy, proud, disappointed), or any other suitable term. The relevancy score may be a function of the social data associated with lookalike users and friends of a querying user. The relevancy score may be expressed as R=f (x, y, z, . . . ) where R is the relevancy score and x, y, z, . . . are terms associated with the online social network. When a querying user inputs a search query, the social-networking system 160 may identify one or more matching terms that become a subset of all the terms associated with the online social network. The machine-learning model may then take the matching terms and return the relevancy score for those terms, which may have been pre-calculated. The relevancy score may be expressed generically as R=f(x, y, z, . . . )=[Aₓ, B_{y}, C_{z} . . . ], where Aₓ, B_{y}, C_{z} . . . represent the output of the machine-learning model. As an example and not by way of limitation, a user Alex may search “where is a good vacation spot” the online social-networking system may identify three different vacation destinations: Maui, Hawaii, Miami, Florida, and Banff, Canada. The machine-learning model may have already determined the relevancy score of these terms based on the social data of Alex's lookalike users and friends using the methods described herein. The social-networking system 160 may return references to these three locations and rank the references based in part on their respective relevancy scores. Although this disclosure describes calculating relevancy scores in a particular manner, this disclosure contemplates calculating relevancy scores in any suitable manner.

Ranking Search Results Based on Relevancy Scores

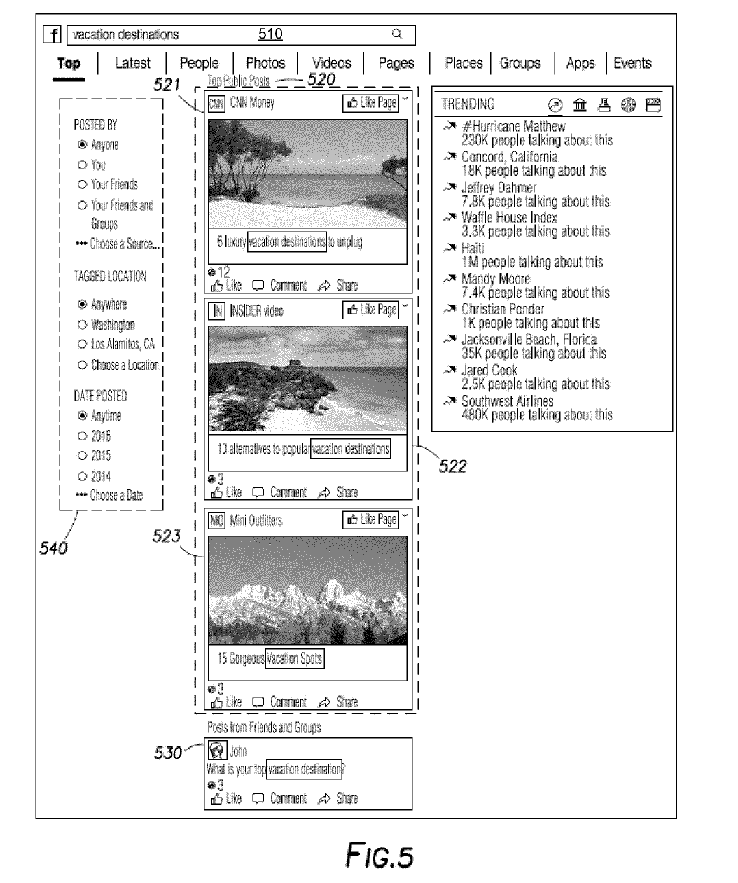

FIG. 5 illustrates an example search-results interface that has been adjusted using the method described herein. The search-results interface may comprise a query field 510, public posts 520 comprising top posts 521, 522, and 523, posts from friends and groups 530, and structured search option panel 540. Posts from friends and groups 530 may comprise content objects, status updates, and other suitable information that the querying user's friends and fellow group members have posted to the online social network. Structured search option panel 540 may comprise several options for a user to filter a search query. As an example and not by way of limitation, the querying user may select to search among only posts that were posted in a particular geographic area (e.g., Los Alamitos, Calif.). The top posts 521, 522, and 523 may be ranked according to the relevancy score assigned to them by the machine-learning model. As described above, the machine-learning model may have been trained with social-networking data from the querying user's lookalike users. As an example and not by way of limitation, a querying user may have input into the query field “vacation destinations.” The lookalike users for this particular querying user may have relatively more prior interactions with tropical beach vacations (e.g., they post and interact with content objects related to tropical beach destinations more than other types of vacation destinations). This may cause the content objects identified by the social-networking system 150 to be assigned different relevancy scores, where the content objects related to tropical beach vacations receive a higher relevancy score than content objects related to other types of environments (e.g., tours of Antarctica, ski resorts, rain forests). Thus, top posts 521 and 522 may be ranked higher than top post 523. In particular embodiments, a reference may be ranked among the top posts of a search-results interface even though it is not an exact keyword match or even though there are other references that may be more relevant to the text of the search query. The reason for this may be because lookalike users with respect to the querying user may have interacted with a particular post more than other posts. Because the querying user's lookalike users found the post to be especially relevant or interesting, it is likely that the querying user may find the post relevant or interesting as well. Thus, search results that may only be tangentially related to a search query may be ranked highly because the querying user's lookalike users interacted with the search result at a disproportionately high rate. Although this disclosure describes providing a search-results interface in a particular manner, this disclosure contemplates providing a search-results interface in any suitable manner.

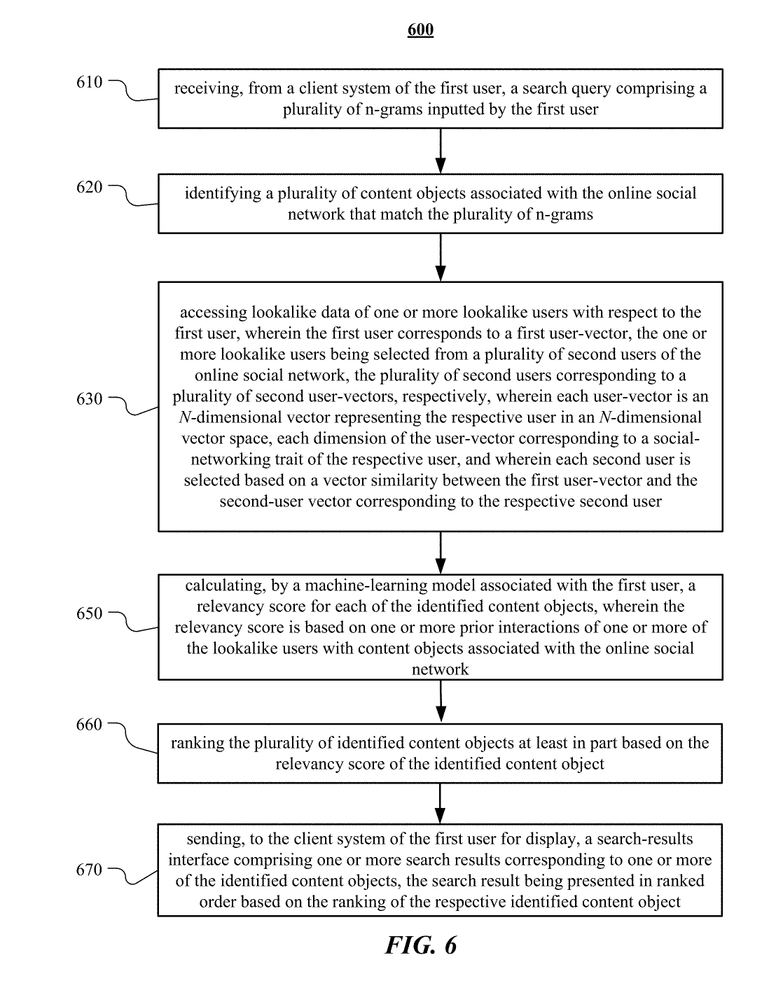

FIG. 6 illustrates an example method 600 for ranking search results based on social data from lookalike users. The method may begin at step 610, where the social-networking system 160 may receive from a client system of the first user, a search query comprising a plurality of n-grams inputted by the first user. At step 620, the social-networking system 160 may identify a plurality of content objects associated with the online social network that match the plurality of n-grams. At step 630, the social-networking system 160 may access lookalike data of one or more lookalike users with respect to the first user, wherein the first user corresponds to a first user-vector, the one or more lookalike users being selected from a plurality of second users of the online social network, the plurality of second users corresponding to a plurality of second user-vectors, respectively, wherein each user-vector is an N-dimensional vector representing the respective user in an N-dimensional vector space, each dimension of the user-vector corresponding to a social-networking trait of the respective user, and wherein each second user is selected based on a vector similarity between the first user-vector and the second-user vector corresponding to the respective second user. At step 640, the social-networking system 160 may calculate, by a machine-learning model associated with the first user, a relevancy score for each of the identified content objects, wherein the relevancy score is based on one or more prior interactions of one or more of the lookalike users with content objects associated with the online social network. At step 650, the social-networking system 160 may rank the plurality of identified content objects at least in part based on the relevancy score of the identified content object. At step 660, the social-networking system 160 may send, to the client system of the first user for display, a search-results interface comprising one or more search results corresponding to one or more of the identified content objects, the search result being presented in ranked order based on the ranking of the respective identified content object. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for ranking search results based on social data from lookalike users including the particular steps of the method of FIG. 6, this disclosure contemplates any suitable method for ranking search results based on social data from lookalike users including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Social Graph Affinity and Coefficient

In particular embodiments, the social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile interfaces, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the social-networking system 160 may calculate a coefficient based on a user's actions. The social-networking system 160 may monitor such actions on the online social network, on a third-party system 170, on other suitable systems, or any combination thereof. Any suitable type of user actions may be tracked or monitored. Typical user actions include viewing profile interfaces, creating or posting content, interacting with content, tagging or being tagged in images, joining groups, listing and confirming attendance at events, checking-in at locations, liking particular interfaces, creating interfaces, and performing other tasks that facilitate social action. In particular embodiments, the social-networking system 160 may calculate a coefficient based on the user's actions with particular types of content. The content may be associated with the online social network, a third-party system 170, or another suitable system. The content may include users, profile interfaces, posts, news stories, headlines, instant messages, chat room conversations, emails, advertisements, pictures, video, music, other suitable objects, or any combination thereof. The social-networking system 160 may analyze a user's actions to determine whether one or more of the actions indicate an affinity for subject matter, content, other users, and so forth. As an example and not by way of limitation, if a user frequently posts content related to “coffee” or variants thereof, the social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile interface for the second user.

In particular embodiments, the social-networking system 160 may calculate a coefficient based on the type of relationship between particular objects. Referencing the social graph 200, the social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, the social-networking system 160 may determine that the user has a higher coefficient with respect to the first photo than the second photo because having a tagged-in-type relationship with content may be assigned a higher weight and/or rating than having a like-type relationship with content. In particular embodiments, the social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, the social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, the social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, the social-networking system 160 may determine that the user has a higher coefficient for the airport than the gas station based on the proximity of the airport to the user.

In particular embodiments, the social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the social-networking system 160 may provide information that is relevant to user's interests and current circumstances, increasing the likelihood that they will find such information of interest. In particular embodiments, the social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, the social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results interface than results corresponding to objects having lower coefficients.

In particular embodiments, the social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, the social-networking system 160 may calculate the coefficient (or access the coefficient information if it has previously been calculated and stored). In particular embodiments, the social-networking system 160 may measure an affinity with respect to a particular process. Different processes (both internal and external to the online social network) may request a coefficient for a particular object or set of objects. The social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. patent application Ser. No. 12/978265, filed 23 Dec. 2010, and U.S. patent application Ser. No. 13/632869, filed 1 Oct. 2012, each of which is incorporated by reference.

### Systems and Methods

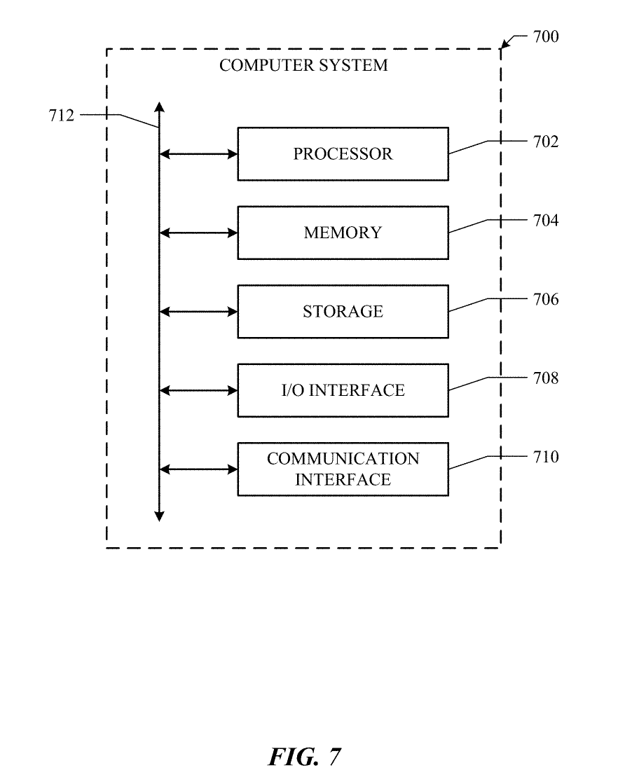

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, from a client system of the first user, a search query comprising a plurality of n-grams inputted by the first user;
identifying a plurality of content objects associated with the online social network that match the plurality of n-grams;
accessing lookalike data of one or more lookalike users with respect to the first user, wherein the first user corresponds to a first user-vector, the one or more lookalike users being selected from a plurality of second users of the online social network, the plurality of second users corresponding to a plurality of second user-vectors, respectively, wherein each user-vector is an N-dimensional vector representing the respective user in an N-dimensional vector space, each dimension of the user-vector corresponding to a social-networking trait of the respective user, and wherein each second user is selected based on a vector similarity between the first user-vector and the second-user vector corresponding to the respective second user;
calculating, by a machine-learning model associated with the first user, a relevancy score for each of the identified content objects, wherein the relevancy score is based on one or more prior interactions of one or more of the lookalike users with content objects associated with the online social network;
ranking the plurality of identified content objects at least in part based on the relevancy score of the identified content object; and
sending, to the client system of the first user for display, a search-results interface comprising one or more search results corresponding to one or more of the identified content objects, the search result being presented in ranked order based on the ranking of the respective identified content object.

2. The method of claim 1, wherein the social-networking trait of the respective user is determined by accessing a social graph comprising a plurality of nodes and a plurality of edges connecting the nodes, each of the edges between two of the nodes representing a single degree of separation between them, wherein a particular node in the social graph corresponds to the respective user.

3. The method of claim 2, wherein each of the edges comprise an edge-type corresponding to a specific interaction the respective user has taken with respect to another particular node in the social graph.

4. The method of claim 1, wherein the lookalike data for a particular lookalike user comprises social-networking traits associated with the particular lookalike user, and wherein the social-networking traits comprise one or more prior interactions the lookalike user has taken in association with the online social network.

5. The method of claim 1, wherein the prior interactions of the one or more lookalike users comprise viewing, accessing, liking, sharing, commenting on, or reacting to the content objects associated with the online social network.

6. The method of claim 1, wherein the prior interactions of the one or more lookalike users comprise click-through data associated with search results previously presented to the respective lookalike user.

7. The method of claim 1, wherein each user-vector comprises information associated with prior interactions associated with the respective user.

8. The method of claim 1, wherein, for each second user selected as a lookalike user, the vector similarity between the first user-vector and the second user-vector corresponding to the respective second user is above a threshold similarity value.

9. The method of claim 1, wherein the vector similarity is calculated using cosine similarity between the user-vectors.

10. The method of claim 1, wherein the vector similarity is calculated by calculating the Euclidean distance between the user-embeddings of the user-vectors.

11. The method of claim 1, wherein the user-vectors are binary user-vectors, and the vector similarity is calculated using Hamming distance between the vectors.

12. The method of claim 1, wherein the machine-learning model is trained with content data of a plurality of content objects associated with prior interactions of one or more of the lookalike users.

13. The method of claim 1, wherein the machine-learning model is trained with interaction data of prior interactions with content objects by one or more of the lookalike users.

14. The method of claim 1, wherein the relevancy score for each of the identified content objects represents a probability that the first user will interact with the search result corresponding to the identified content object.

15. The method of claim 1, wherein the relevancy score is further based on social data associated with one or more users connected to the first user within the online social network.

16. The method of claim 1, wherein the content objects comprise one or more of: posts, comments, videos, photos, business pages, location pages, or user pages.

17. One or more computer-readable non-transitory storage media embodying software that is operable when executed to:
receive, from a client system of the first user, a search query comprising a plurality of n-grams inputted by the first user;
identify a plurality of content objects associated with the online social network that match the plurality of n-grams;
access lookalike data of one or more lookalike users with respect to the first user, wherein the first user corresponds to a first user-vector, the one or more lookalike users being selected from a plurality of second users of the online social network, the plurality of second users corresponding to a plurality of second user-vectors, respectively, wherein each user-vector is an N-dimensional vector representing the respective user in an N-dimensional vector space, each dimension of the user-vector corresponding to a social-networking trait of the respective user, and wherein each second user is selected based on a vector similarity between the first user-vector and the second-user vector corresponding to the respective second user;
calculate, by a machine-learning model associated with the first user, a relevancy score for each of the identified content objects, wherein the relevancy score is based on one or more prior interactions of one or more of the lookalike users with content objects associated with the online social network;
rank the plurality of identified content objects at least in part based on the relevancy score of the identified content object; and
send, to the client system of the first user for display, a search-results interface comprising one or more search results corresponding to one or more of the identified content objects, the search result being presented in ranked order based on the ranking of the respective identified content object.

18. A system comprising: one or more processors; and a non-transitory memory coupled to the processors comprising instructions executable by the processors, the processors operable when executing the instructions to:
receive, from a client system of the first user, a search query comprising a plurality of n-grams inputted by the first user;
identify a plurality of content objects associated with the online social network that match the plurality of n-grams;
access lookalike data of one or more lookalike users with respect to the first user, wherein the first user corresponds to a first user-vector, the one or more lookalike users being selected from a plurality of second users of the online social network, the plurality of second users corresponding to a plurality of second user-vectors, respectively, wherein each user-vector is an N-dimensional vector representing the respective user in an N-dimensional vector space, each dimension of the user-vector corresponding to a social-networking trait of the respective user, and wherein each second user is selected based on a vector similarity between the first user-vector and the second-user vector corresponding to the respective second user;
calculate, by a machine-learning model associated with the first user, a relevancy score for each of the identified content objects, wherein the relevancy score is based on one or more prior interactions of one or more of the lookalike users with content objects associated with the online social network;
rank the plurality of identified content objects at least in part based on the relevancy score of the identified content object; and
send, to the client system of the first user for display, a search-results interface comprising one or more search results corresponding to one or more of the identified content objects, the search result being presented in ranked order based on the ranking of the respective identified content object.
